(19) United States
(12) Patent Application Publication
(10) Pub. No.: US 2019/0080109 A1
(43) Pub. Date: Mar. 14, 2019

(54) INFORMATION PROCESSING APPARATUS AND NON-TRANSITORY COMPUTER READABLE MEDIUM

(71) Applicant: FUJI XEROX CO., LTD., Tokyo (JP)

(72) Inventors: Akio YAMASHITA, Kanagawa (JP); Katsuyuki KONDO, Kanagawa (JP)

(73) Assignee: FUJI XEROX CO., LTD., Tokyo (JP)

(21) Appl. No.: 15/913,391

(22) Filed: Mar. 6, 2018

(30) Foreign Application Priority Data
Sep. 12, 2017 (JP) 2017-174680

(51) Int. Cl. G06F 21/62; G07C 13/00; H04L 29/06

(52) U.S. Cl. CPC G06F 21/6218; H04L 63/102; G07C 13/00

(57) ABSTRACT

An information processing apparatus includes a receiver, a sender, and a setter. The receiver receives a setting request to set an access right to access content for a user. The sender sends a voting request to a user authorized to access the content. The voting request is a request to vote upon whether to accept the setting request. The setter executes calculation processing on information received in response to the voting request and sets the access right if a result of the calculation processing satisfies a predetermined condition.

### CROSS-REFERENCE TO RELATED APPLICATIONS

This application is based on and claims priority under 35 USC 119 from Japanese Patent Application No. 2017-174680 filed Sep. 12, 2017.

### BACKGROUND

### (i) Technical Field

The present invention relates to an information processing apparatus and a non-transitory computer readable medium.

### (ii) Related Art

Various technologies for managing rights to use content, such as digital documents, have been proposed.

### SUMMARY

According to an aspect of the invention, there is provided an information processing apparatus including a receiver, a sender, and a setter. The receiver receives a setting request to set an access right to access content for a user. The sender sends a voting request to a user authorized to access the content. The voting request is a request to vote upon whether to accept the setting request. The setter executes calculation processing on information received in response to the voting request and sets the access right if a result of the calculation processing satisfies a predetermined condition.

### BRIEF DESCRIPTION OF THE DRAWINGS

An exemplary embodiment of the present invention will be described in detail based on the following figures, wherein:

FIG. 1 is a block diagram illustrating an example of the configuration of an access right management system;

FIG. 2 is a block diagram illustrating an example of the functional configuration of the access right management system;

FIG. 3 is a block diagram illustrating an example of the hardware configuration of a user terminal;

FIG. 4 is a block diagram illustrating an example of the hardware configuration of a server;

FIG. 5 illustrates an example of a content management table;

FIG. 6 illustrates an example of an access management table;

FIG. 7 illustrates an example of an access control list (ACL);

FIG. 8 is a flowchart illustrating processing executed by the access right management system;

FIG. 9 is a flowchart illustrating an example of voting processing for a read right and calculation processing for voting results;

FIG. 10 is a flowchart illustrating narrow-down processing for authorization holders;

FIG. 11 illustrates examples of functions used for narrow-down processing;

FIG. 12 illustrates an example of a list of authorization holders;

FIG. 13 illustrates an example of a list of authorization holders restricted by narrow-down processing;

FIG. 14 is a flowchart illustrating voting processing;

FIG. 15 illustrates examples of a voting screen displayed on a user interface (UI) of a user terminal;

FIG. 16 illustrates examples of calculation methods;

FIG. 17 illustrates examples of details of calculation processing and judging processing on voting results;

FIG. 18 is an example of an ACL;

FIG. 19 is a sequence diagram illustrating processing executed by the access right management system; and

FIG. 20 illustrates an example of a list of authorization holders.

### DETAILED DESCRIPTION

### [1] CONFIGURATION

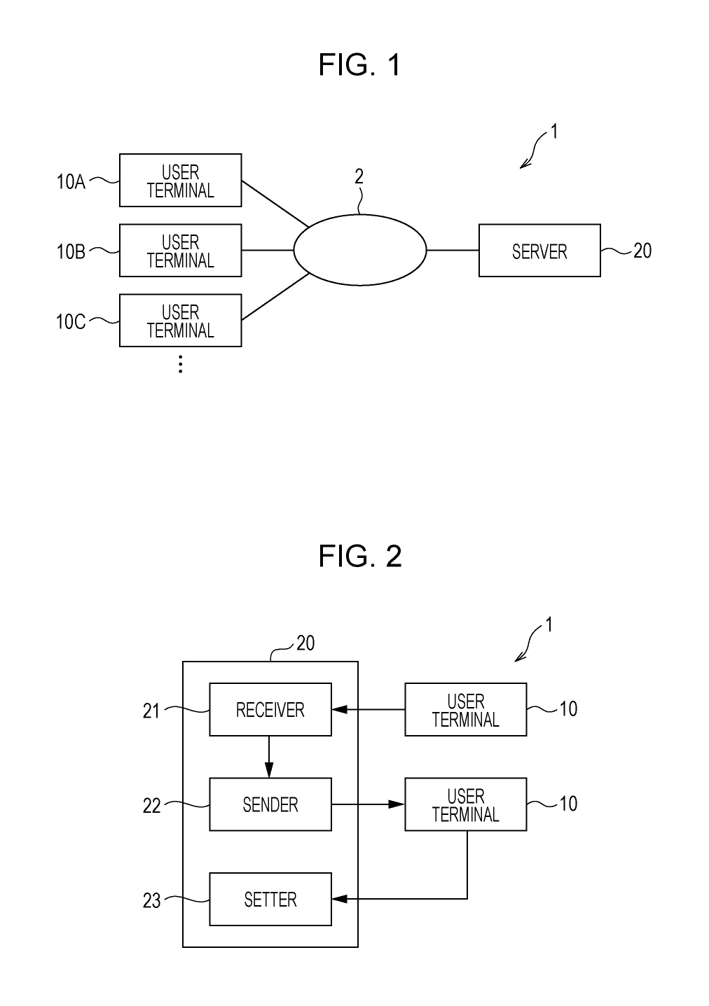

FIG. 1 is a block diagram illustrating the configuration of an access right management system 1 according to an exemplary embodiment. The access right management system 1 includes user terminals 10A, 10B, and 10C and a server 20. The server 20 is an example of an information processing apparatus. Examples of the user terminals 10A, 10B, and 10C are smartphones, tablet terminals, and laptop personal computers (PCs). In the following description, the user terminals 10A, 10B, and 10C will collectively be called the user terminal 10 unless it is necessary to distinguish them from each other. The user terminal 10 is connected to the server 20 via a communication line 2. The communication line 2 includes at least one of the Internet, a mobile communication network, a telephone line, and a local area network (LAN). The server 20 provides various services, such as storage services. Among the various services, the server 20 manages access rights for registered content.

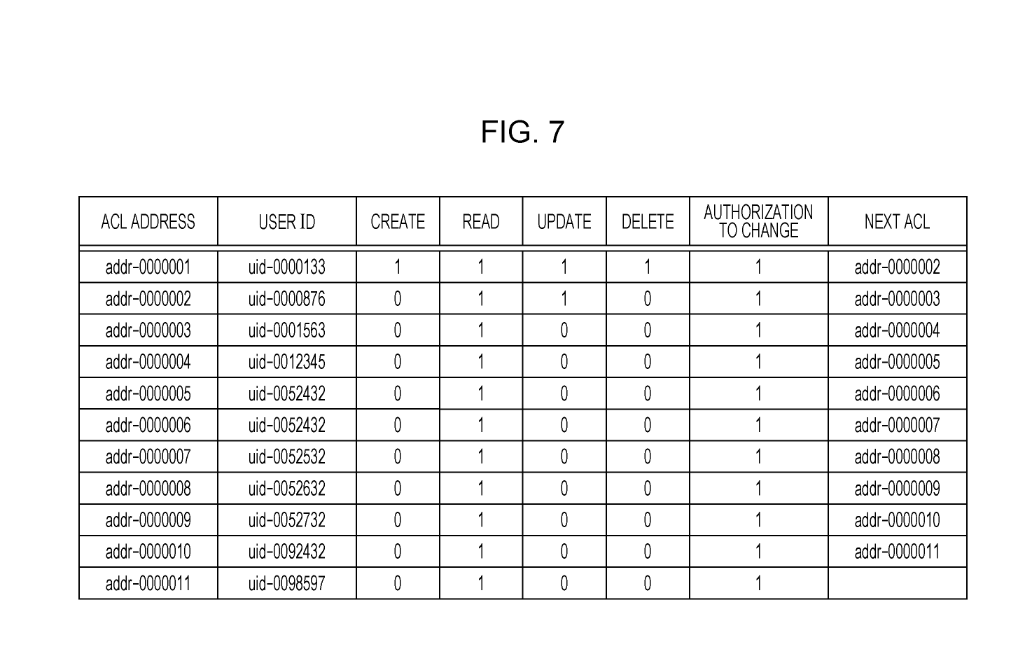

In this exemplary embodiment, the server 20 manages access rights for content by using an access management table, such as that shown in FIG. 6, and an access control list (hereinafter simply called an “ACL”), such as that shown in FIG. 7. The ACL is a list for managing access rights for each piece of content. The ACL includes a list of user IDs having access rights for a certain piece of content. In this exemplary embodiment, the ACL is provided for each piece of content, and the accessibility to a certain piece of content by a requester user is determined according to whether the user ID of this user is included in the ACL for this piece of content. Content may be stored in a memory of the server 20 or in an external server.

FIG. 2 is a block diagram illustrating the functional configuration of the access right management system 1. As shown in FIG. 2, the server 20 includes a receiver 21, a sender 22, and a setter 23. The receiver 21 receives a request to set an access right to access a certain piece of content for a user. The sender 22 sends a voting request to users authorized to access this piece of content to ask them to vote upon whether to accept the request to set an access right. In this exemplary embodiment, the voting request is a request to vote upon whether to accept a request to set an access right and to be sent to the user terminals 10 of plural users. Upon receiving a voting request, the user terminal 10 displays a voting screen on a display panel, for example, and instructs the user to vote. The plural users look at the information displayed on the screen and operate the voting screen to vote upon whether to accept a request to set an access right. The voting results obtained from the plural users are calculated by the server 20. The setter 23 executes calculation processing on information received in response to the voting request sent by the sender 22. If the processed results satisfy predetermined conditions, the setter 23 sets an access right for a requester user.

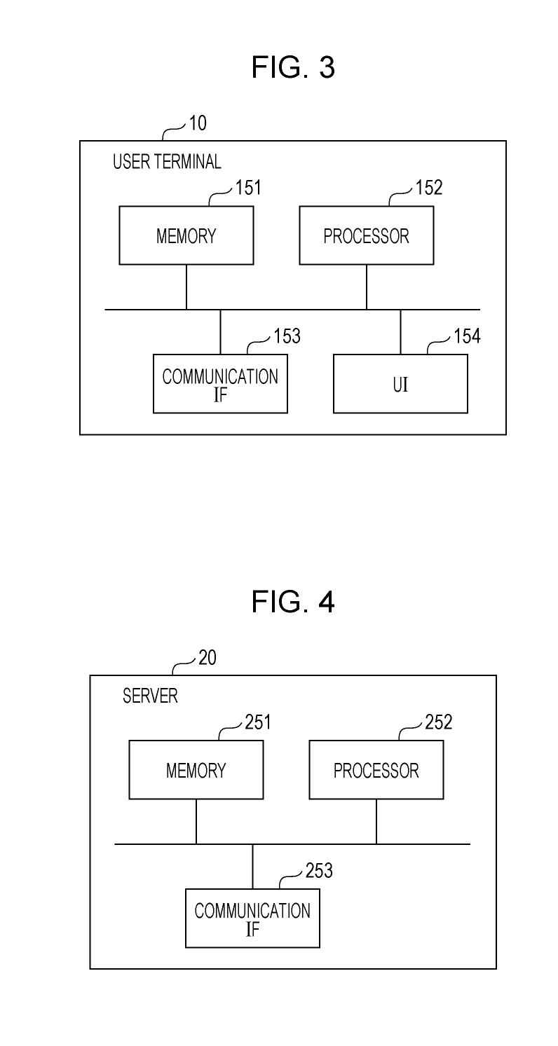

FIG. 3 illustrates an example of the hardware configuration of the user terminal 10. A memory 151 stores various items of data. A processor 152 executes data processing in accordance with programs stored in the memory 151. A communication interface (IF) 153 is an interface which performs data communication with external devices via the communication line 2. A user interface (UI) 154 includes a touchscreen and keys, for example.

FIG. 4 illustrates an example of the hardware configuration of the server 20. A memory 251 stores various items of data. A processor 252 executes data processing in accordance with programs stored in the memory 251. A communication IF 253 is an interface which performs data communication with external devices via a network.

In this example, as a result of the processor 252 executing the programs stored in the memory 251, the functions shown in FIG. 2 are implemented. The processor 252 executing the programs is an example of the receiver 21, the sender 22, and the setter 23.

In this exemplary embodiment, the server 20 manages content and access rights by using a content management table and an access management table stored in the memory 251.

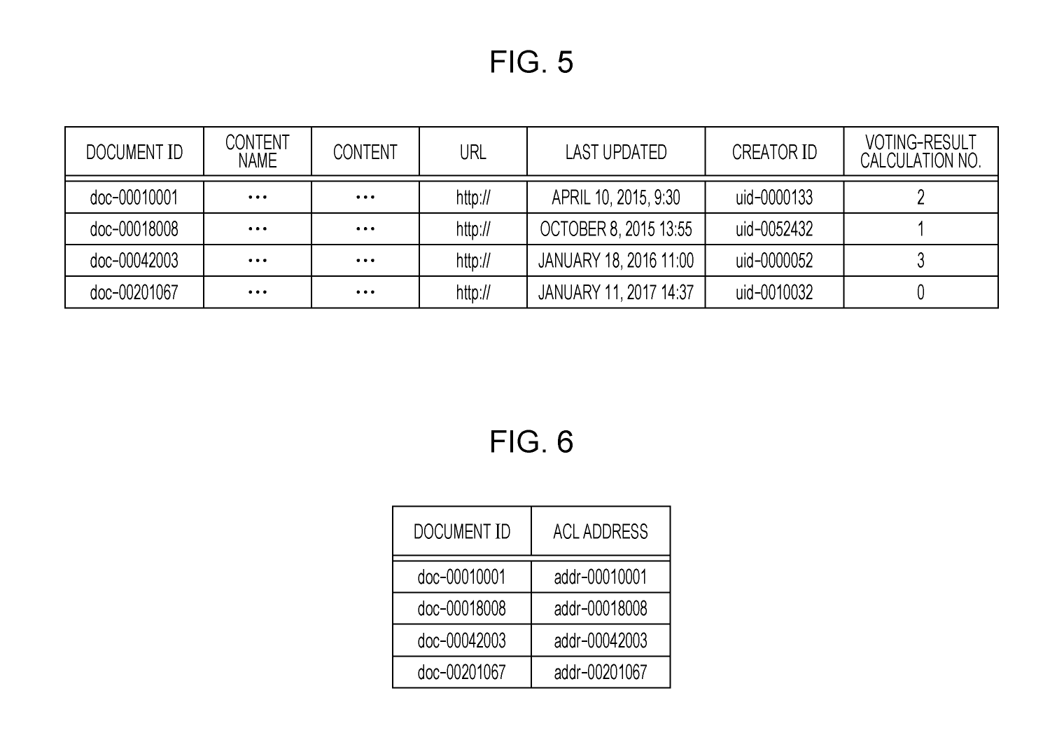

FIG. 5 illustrates an example of the content management table. In the content management table, fields “document ID”, “content name”, “content”, “URL”, “last updated”, “creator ID”, and “voting-result calculation No.” are related to each other. In the “document ID” field, identification information for identifying content is stored. In the “content name” field, text information indicating the file name of the content is stored. In the “content” field, data indicating details of the content is stored. In the “URL” field, address information indicating a storage location of the content is stored. In the “last updated” field, information indicating the latest date on which the content is updated is stored. In the “creator ID” field, a user ID for identifying the creator of the content is stored.

In the “voting-result calculation No.” field, information for identifying the calculation method to be used for judging processing whether to accept a request to set an access right for the content is stored. The calculation method for voting results will be discussed later.

FIG. 6 illustrates an example of the access management table. In this example of the access management table, fields “document ID” and “ACL address” are related to each other. In the “document ID” field, identification information for identifying content is stored. In the “ACL address” field, the address of an ACL is stored. The ACL is provided for each piece of content.

In this exemplary embodiment, access rights for content include a create right, a read right, an update right, a delete right, and authorization to change rights. The create right is a right to create content. The read right is a right to read content. The update right is a right to update content. The delete right is a right to delete content. Authorization to change rights is authorization to change the access rights for content.

FIG. 7 illustrates an example of the ACL. In this example, the ACL is a list of records in which fields “ACL address”, “user ID”, “create”, “read”, “update”, “delete”, “authorization to change”, and “next ACL” are related to each other. In the “ACL address” field, information indicating the address of an ACL record for a certain piece of content is stored. In the “user ID” field, the user ID for identifying a user having an access right for this piece of content is stored. In the “create”, “read”, “update”, “delete”, “authorization to change” fields, flags indicating whether a create right, a read right, an update right, a delete right, and authorization to change rights are granted to this user are stored. In this example, “1” indicates that a corresponding right is granted to the user, while “0” indicates that a corresponding right is not granted to the user.

In the example in FIG. 7, the user (creator) created the content associated with the ACL identified by “addr-0000001 is the user identified by the user ID “uid-0000133”, and the create right, read right, update right, and delete right are granted to this user. Concerning the user identified by the user ID “uid-0001563”, the read right is granted, but the update right and the delete right are not granted. That is, this user has a right to read the content, but does not have a right to update or delete the content. In the example in FIG. 7, the read right is granted to all the eleven users identified by the user IDs “uid-0000133”, “uid-0000876”, . . . , “uid-0098597” in the list.

In the “next ACL” field, a pointer representing the storage address of the next record (record for another user to which an access right for this content is granted) is stored.

### [2] OPERATION

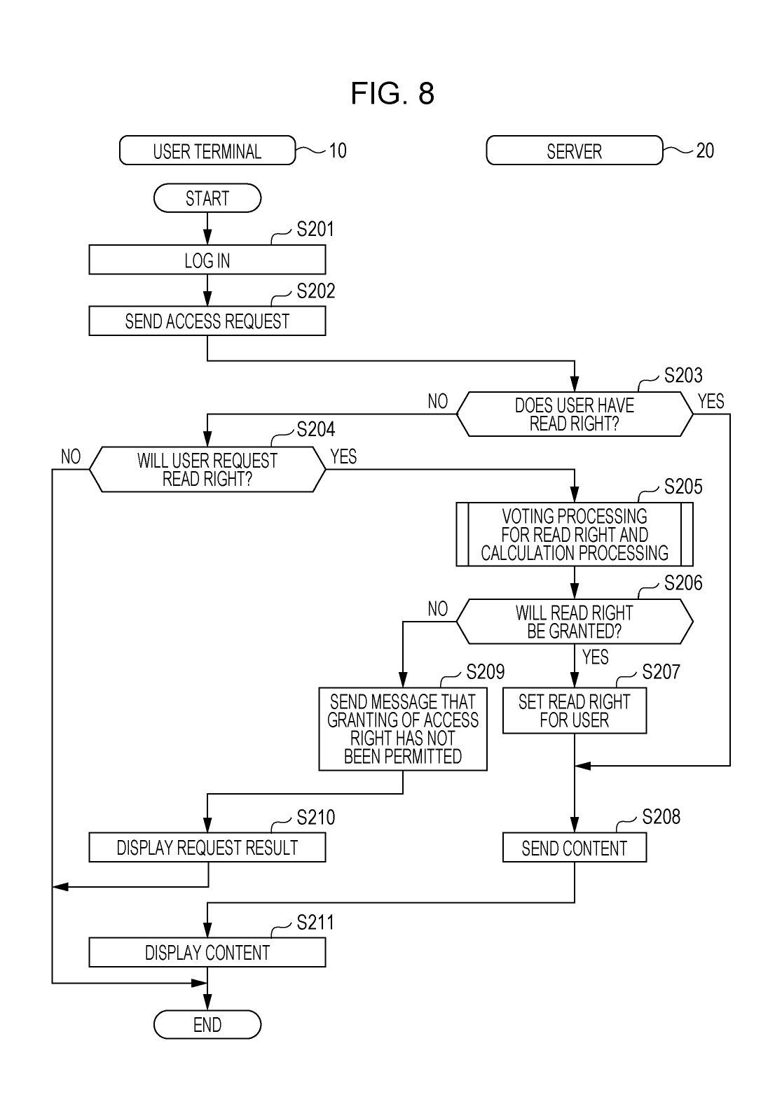

FIG. 8 is a flowchart illustrating processing executed by the access right management system 1. More specifically, FIG. 8 illustrates processing executed when a requester user requests a read right for content. In step S201, the processor 152 of the user terminal 10 logs in the server 20. More specifically, the processor 152 sends a login request including login information indicating a user ID and a password to the server 20, and the server 20 conducts user authentication by using the login information. The server 20 then sends a response indicating the user authentication result to the user terminal 10.

In step S202, the processor 152 sends an access request to access content to the server 20. The access request includes the user ID for identifying this user and a URL indicating the storage location of the content (hereinafter called the content URL).

In step S203, the processor 252 of the server 20 determines whether the user has a read right for this content, based on the user ID included in the access request. The processor 252 makes this determination by referring to the access management table. It is now assumed that the access management table is the one shown in FIG. 6 and the processor 252 checks for a read right for the content identified by the document ID “doc-00010001”. In this case, the processor 252 accesses the ACL by using the ACL address “addr-00010001” linked with the document ID “doc-00010001” and determines whether this user ID is registered in the ACL and whether a read right is granted to this user ID if the user ID is registered. If the processor 252 judges in step S203 that the user has a read right, it proceeds to step S208. If the processor 252 judges in step S203 that the user does not have a read right, it informs the user terminal 10 that the user does not have a read right and proceeds to step S204.

In step S204, the processor 152 of the user terminal 10 determines whether to request a read right. The processor 152 may make this determination by causing the UI 154 to display a screen for instructing the user to select whether to make a request and by judging the selection made by the user. If the processor 152 judges that the user will request a read right, it sends a request indicating this information to the server 20. The process then proceeds to step S205. If the processor 152 judges that the user will not request a read right, it terminates the processing.

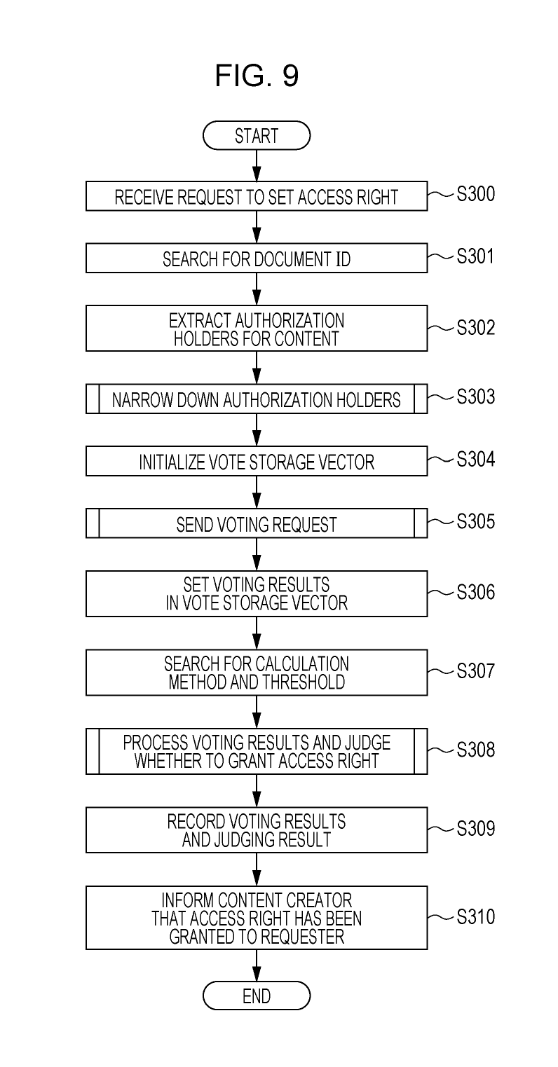

In step S205, the processor 252 executes voting processing for a read right and calculation processing for voting results. The calculation processing will be discussed later with reference to FIG. 9. In step S206, the processor 252 determines whether to grant a read right in accordance with the calculation results. If the processor 252 determines that a read right will be granted (YES in step S206), it proceeds to step S207. If the processor 252 determines that a read right will not be granted (NO in step S206), it proceeds to step S209.

In step S207, if the calculation results obtained in step S205 satisfy predetermined conditions, the processor 252 executes processing for setting a read right for the user. In this exemplary embodiment, the processor 252 adds a record of this user to the ACL associated with this content, and sets a value indicating that the user has a read right in the read flag of this user.

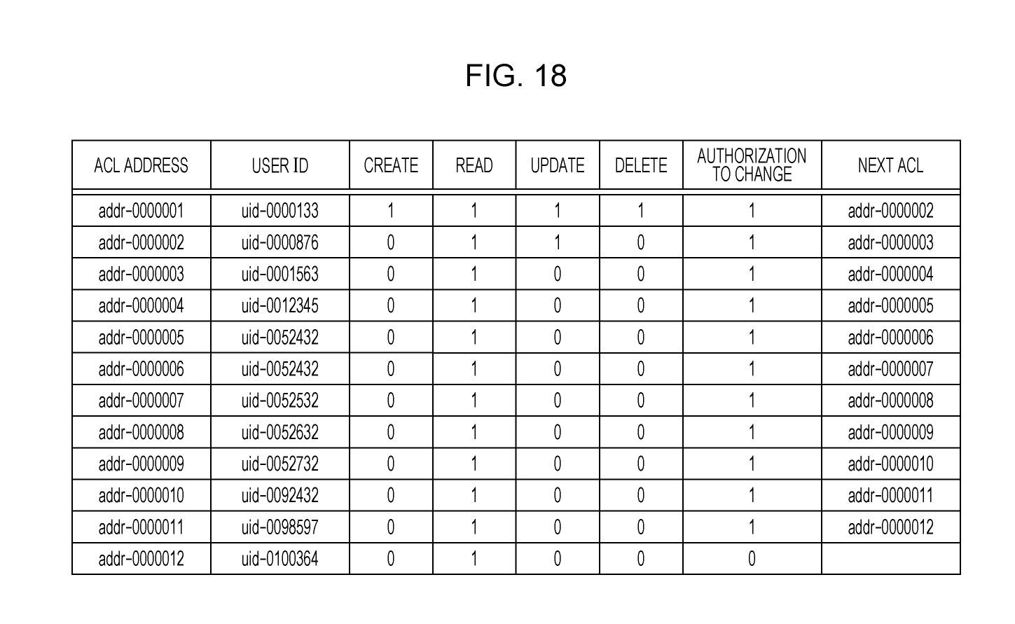

FIG. 18 is an example of the ACL when a read right is granted to the requester user. The example in FIG. 18 shows a state in which a record of the requester user is added to the ACL in FIG. 7. More specifically, the example in FIG. 18 shows a state in which the user (requester for a read right) identified by the user ID “uid-0100364” is registered in the ACL and a read right is granted to this user (“1” is set in “read”).

Referring back to FIG. 8, in step S208, the processor 252 reads the content from the memory 251 and sends it to the user terminal 10. If the content is stored in an external source such as an external server, the processor 252 sends a request to send the content to the external server and receives the content from the external server. The processor 252 then sends the content to the user terminal 10. The process then proceeds to step S211. In step S211, the processor 152 causes the UI 154 to display the content. The requester user then checks the content on the UI 154.

In step S209, the processor 252 sends a message indicating that granting of a read right has not been permitted to the user terminal 10. In step S210, the processor 152 displays the request result for a read right.

FIG. 9 is a flowchart illustrating an example of voting processing for a read right and calculation processing for voting results (step S205 in FIG. 8) executed by the server 20. In step S300, the processor 252 receives a request to set an access right to access content for a user. This request includes the content URL. In step S301, the processor 252 searches for the document ID based on the content URL.

In step S302, the processor 252 extracts users having access rights (authorization holders) for this content. In this exemplary embodiment, the processor 252 refers to the access management table to check the ACL linked with this content. Among the users registered in the ACL, the processor 252 extracts users having authorization to change rights as authorization holders.

In step S303, the processor 252 executes narrow-down processing for restricting the authorization holders to users whose attributes satisfy predetermined conditions. In this exemplary embodiment, the processor 252 executes narrow-down processing by determining whether an authorization holder and a requester are friends in a social networking service (SNS) and whether the time zone of an authorization holder is the same as that of the requester. The processor 252 makes this determination by referring to a preset user management table, for example. In the user management table, a list of users registered as friends in an SNS and information concerning the time zone are stored according to the individual user.

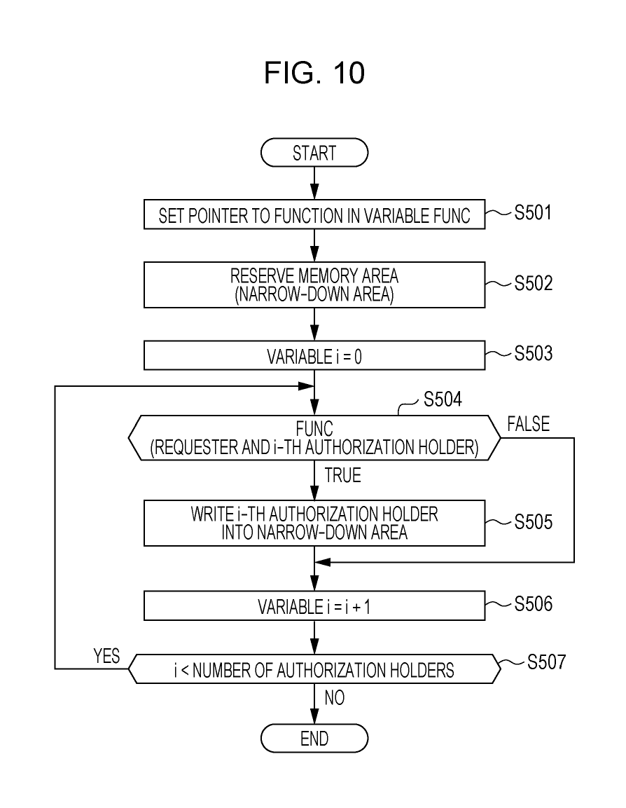

FIG. 10 is a flowchart illustrating narrow-down processing for authorization holders (step S303 in FIG. 9). In step S501, the processor 252 sets a pointer to a function of comparing distances between users in a variable FUNC.

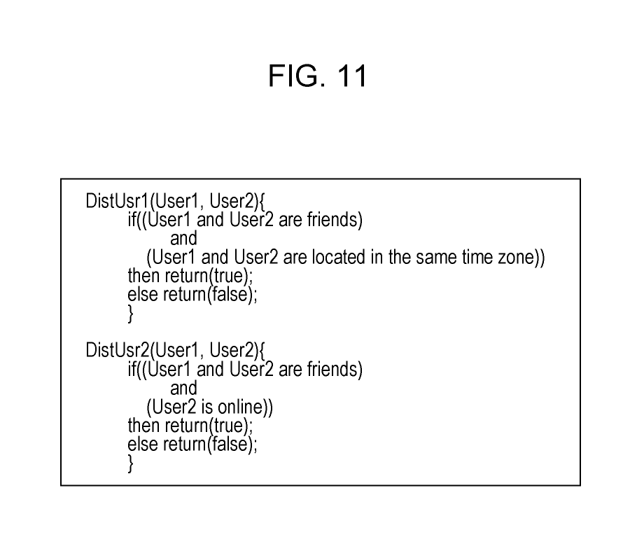

FIG. 11 illustrates examples of the functions used for narrow-down processing. In FIG. 11, two functions DistUsr1 (User1, User2) and DistUsr2 (User1, User2) are shown. The function DistUsr1 indicates that, if “User1” and “User2” are friends and if “User1” and “User2” are located in the same time zone, “true” is returned and if not, “false” is returned.

Referring back to FIG. 10, in step S502, the processor 252 reserves a memory area for storing information concerning an authorization holder for which the return value of the function indicated by the pointer set in the function FUNC is “true” (such an area will hereinafter be called a narrow-down area).

In step S503, the processor 252 sets the value of a variable i to be 0. In step S504, the processor 252 calls the function indicated by the pointer set in the function FUNC by using “requester” and “i-th authorization holder” as arguments. If the return value of the function is “true”, the processor 252 proceeds to step S505. If the return value of the function is “false”, the processor 252 skips step S505 and proceeds to step S506.

In step S505, the processor 252 writes the i-th authorization holder into the narrow-down area. In step S506, the processor 252 increments the variable i. In step S507, the processor 252 determines whether the variable i is smaller than the number of authorization holders extracted in step S302 in FIG. 9. If the variable i is found to be smaller than the number of authorization holders, that is, if some authorization holders are not yet processed, the processor 252 returns to step S504 and executes judging processing for the next authorization holder by using the function. If it is found that the variable i is not smaller than the number of authorization holders, that is, if all the authorization holders extracted in step S302 are processed, the processor 252 completes the processing.

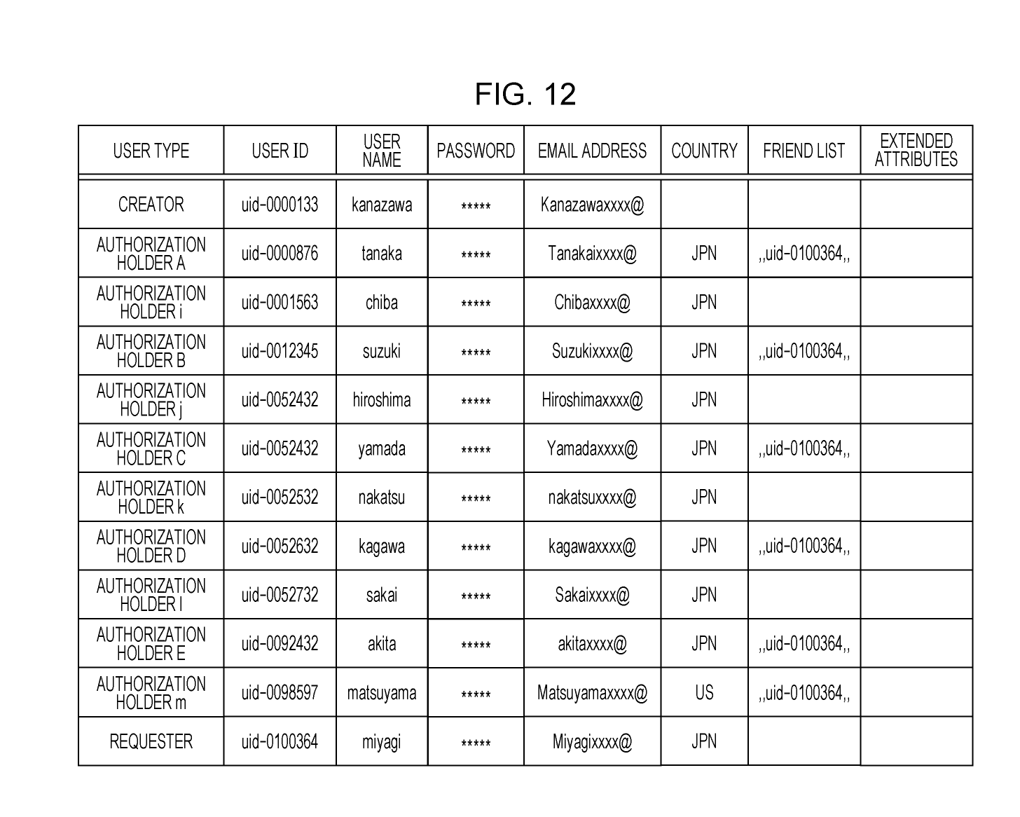

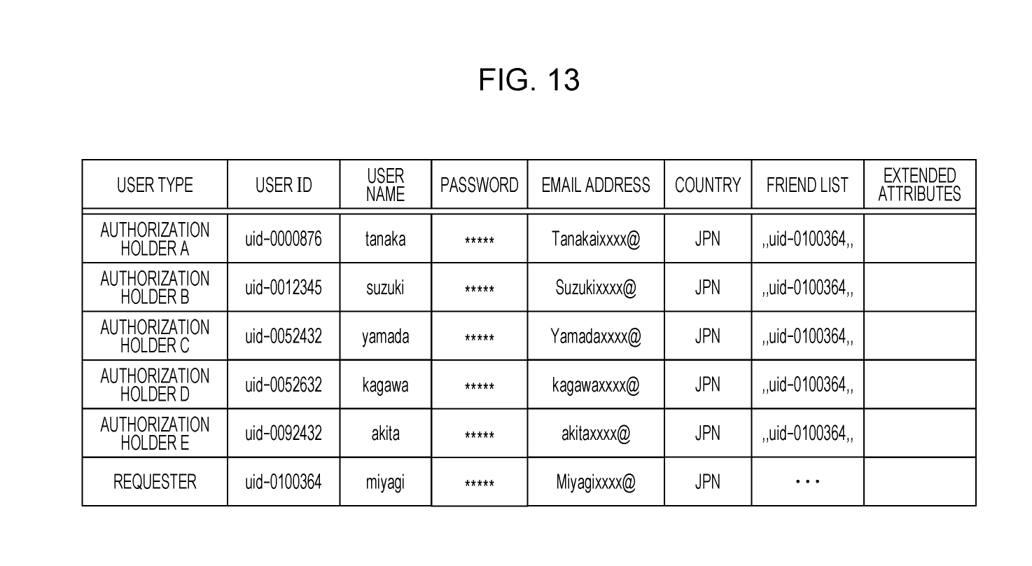

FIG. 12 illustrates an example of a list of the authorization holders extracted in step S302 of FIG. 9. FIG. 13 illustrates an example of a list of the authorization holders restricted by narrow-down processing in step S303 of FIG. 9. In the example in FIG. 12, eleven users including a content creator are extracted as authorization holders. In the list in FIG. 12, the user (uid-0100364), that is, the requester for a read right, is also included. As a result of executing narrow-down processing on the authorization holders in the list in FIG. 12, five authorization holders shown in FIG. 13 are selected as users to be requested to vote.

Referring back to FIG. 9, after processing in step S303, in step S304, the processor 252 initializes each element in a vote storage vector. In step S305, the processor 252 sends a voting request to the selected authorization holders to ask them to vote upon whether to accept the request received in step S300. In this exemplary embodiment, the processor 252 sends a voting request to the authorization holders restricted by narrow-down processing in step S303 to ask them to vote upon whether to set an access right for the requester. This voting request includes the user ID of an authorization holder selected in step S303 and the URL to the screen for instructing the authorization holder to perform voting operation.

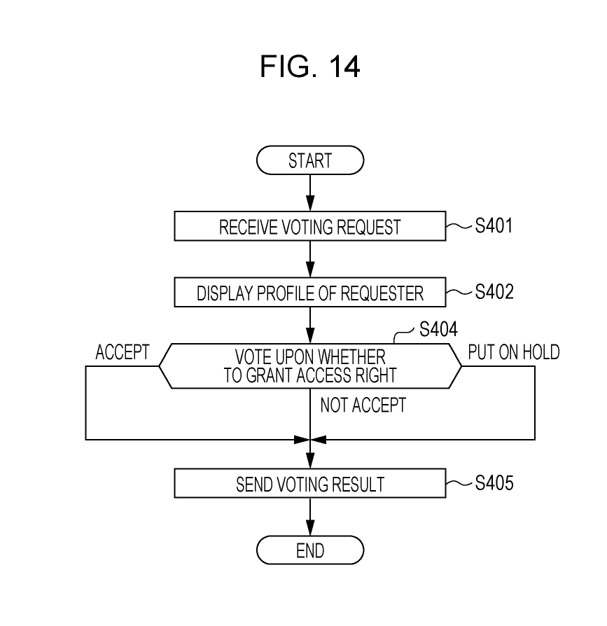

FIG. 14 is a flowchart illustrating voting processing executed by the user terminal 10 of an authorization holder having been requested to vote. In step S401, the processor 152 receives a voting request. The voting request includes information indicating a profile of the requester for a read right. In step S402, the processor 152 causes the UI 154 to display the profile of the requester.

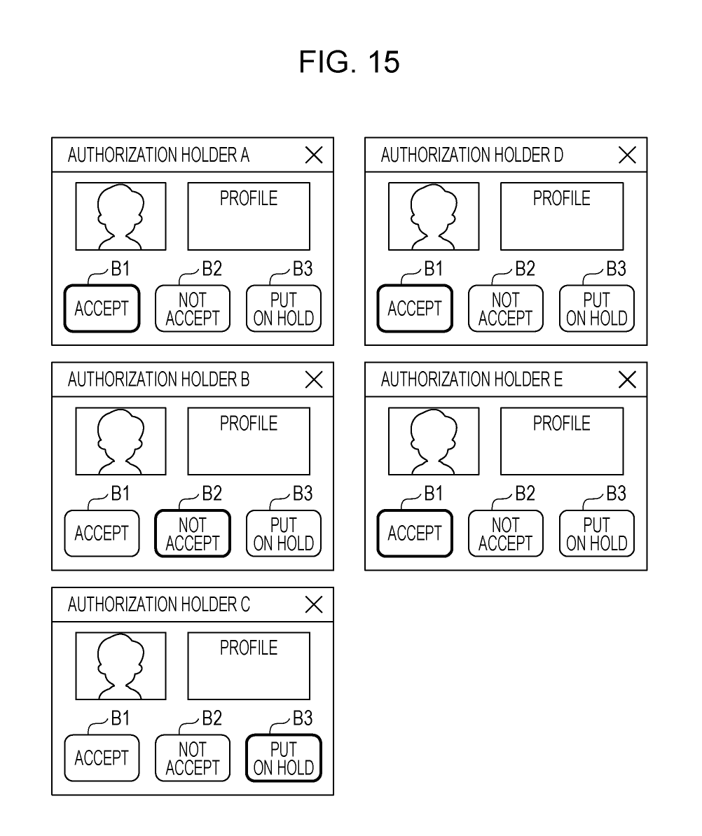

FIG. 15 illustrates examples of the voting screen displayed on the UI 154. In the examples in FIG. 15, the name of an authorization holder is displayed, and also, a face photo and a profile of the requester and buttons B1, B2, and B3 for selecting one of “accept”, “not accept”, and “put on hold” are displayed. The authorization holder verifies the identity of the requester by using the UI 154 of the user terminal 10 and votes upon whether to grant a read right to the requester.

Referring back to FIG. 14, in step S404, the authorization holder votes upon whether to grant an access right. The processor 152 then proceeds to step S405. In step S405, the processor 152 sends information indicating the voting result to the server 20.

Referring back to FIG. 9, the voting results obtained from the authorization holders are processed in the server 20. In step S306, the processor 252 sets the voting results in the vote storage vector. In step S307, the processor 252 then searches the content management table for the calculation method and the threshold linked with the document ID. In the example of the content management table in FIG. 5, “2” is linked with the content ID “doc-00010001” as the voting-result calculation No.

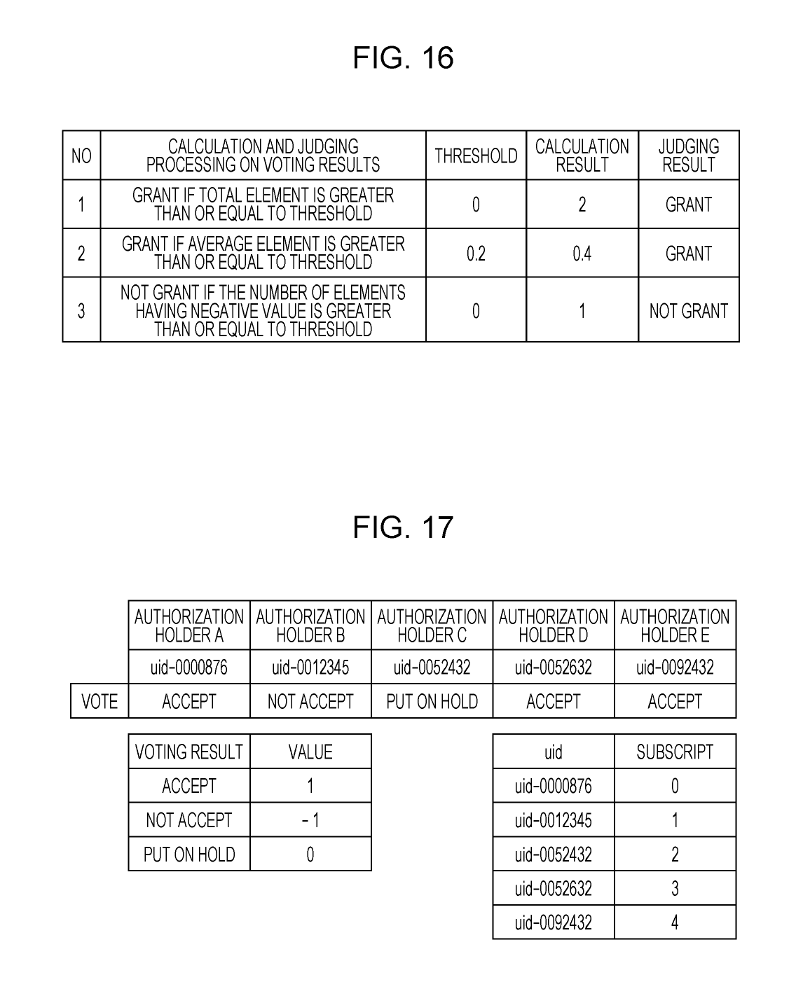

FIG. 16 illustrates examples of the calculation methods and thresholds. In the examples in FIG. 16, three calculation methods “1”, “2”, and “3” are indicated. The calculation method “1” indicates that a read right is granted if the total elements in the vote storage vector (information indicating the voting results obtained from plural authorization holders) is greater than or equal to a threshold. The calculation method “2” indicates that a read right is granted if the average of the elements is greater than or equal to a threshold. The calculation method “3” indicates that a read right is not granted if the number of elements having a negative value is greater than or equal to a threshold. The calculation method and the threshold are preset by a content creator or a content manager for each piece of content.

Referring back to FIG. 9, in step S308, the processor 252 executes calculation processing on information indicating the voting results received in response to the voting request sent in step S305. In this exemplary embodiment, the processor 252 processes the voting results based on the calculation method selected in step S307 to judge whether to grant a read right to the requester.

FIG. 17 illustrates examples of details of calculation processing and judging processing on the voting results. FIG. 17 shows an example in which five authorization holders “authorization holder A”, “authorization holder B”, “authorization holder C”, “authorization holder D”, and “authorization holder E” have been requested to vote and the voting results are “accept” 3, “not accept” 1, and “put on hold” 1. In this exemplary embodiment, calculation processing is conducted, assuming that the element “accept” counts “1”, the element “not accept” counts “−1”, and the element “put on hold” counts “0”. In the example in FIG. 17, if the calculation method “2” in FIG. 16 is selected, the average of the elements is 0.4 and is greater than the threshold 0.2. Accordingly, the processor 252 judges that a read right will be granted.

Referring back to FIG. 9, in step S309, the processor 252 records the voting results and the judging result obtained in step S308 in a log. In step S310, the processor 252 informs the content creator that a read right has been granted to the requester.

A specific example of the operation in this exemplary embodiment will be discussed below. In the following example, the operation to be executed when a requester Ua reads content C1 created by a creator Uc will be described below. The requester Ua first provides an instruction to read the content C1 by using the user terminal 10.

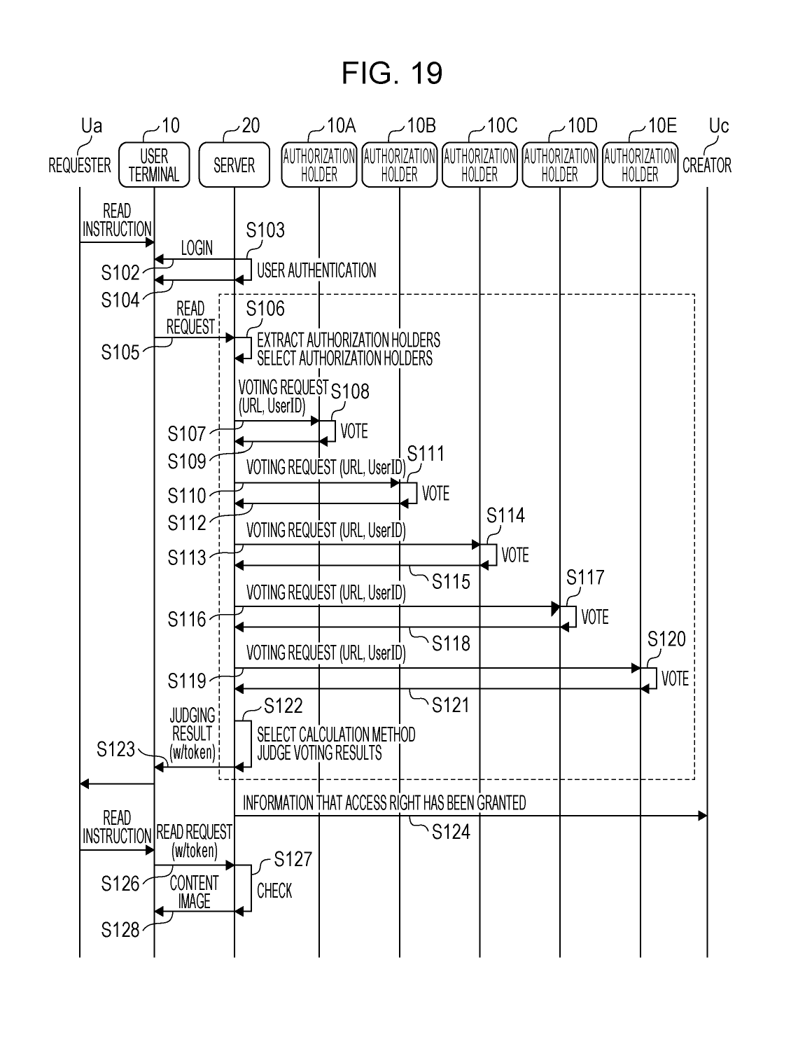

FIG. 19 is a sequence diagram illustrating processing executed by the access right management system 1. In step S102, the processor 152 of the user terminal 10 logs in the server 20. That is, the processor 152 sends a login request including a user ID and a password of the requester Ua to the server 20.

In step S103, the processor 252 of the server 20 conducts user authentication by using the user ID and the password included in the login request. In step S104, the processor 252 sends a response indicating a user authentication result to the user terminal 10.

If the user authentication result indicates that user authentication has succeeded, in step S105, the processor 152 sends a request to read the content C1 to the server 20. Upon receiving a read request from the user terminal 10, in step S106, the processor 252 extracts authorization holders (step S302 in FIG. 9) and executes narrow-down processing to restrict the extracted authorization holders (step S303 in FIG. 9).

In steps S107, S110, S113, S116, and S119, the processor 252 sends a voting request to the user terminals 10 of the authorization holders selected by executing narrow-down processing (step S305 in FIG. 9). The voting request includes the user ID of the authorization holder and the URL to the screen for instructing the user to perform voting operation.

In steps S108, S111, S114, S117, and S120, the processor 152 of the user terminal 10 of the authorization holder executes voting processing in accordance with operation performed by the user (authorization holder). In steps S109, S112, S115, S118, and S121, the processor 152 sends data indicating the voting result to the server 20.

In step S122, the processor 252 selects the calculation method for the voting results (step S307 in FIG. 9) and executes calculation processing according to the selected calculation method so as to judge the voting results (step S308 in FIG. 9). In step S123, the processor 252 sends data indicating the judging result to the user terminal 10 of the requester Ua. The data is appended with a token issued by the server 20. In step S124, the processor 252 informs the creator Uc that an access right has been granted to the user Ua.

Upon receiving data indicating the judging result from the server 20, the processor 152 causes the UI 154 to display an image indicating the judging result. The requester Ua checks the screen displayed on the UI 154 and operates the UI 154 to provide a read instruction. In step S126, the processor 152 sends a request to read the content C1 to the server 20 in accordance with the operation of the requester Ua. The read request includes the token issued by the server 20. Upon receiving the read request, in step S127, the processor 252 conducts authentication by using the token included in the read request. If authentication succeeds, in step S128, the processor 252 sends the content C1 (image data, for example) corresponding to the read request to the user terminal 10 of the sender of the read request.

Upon receiving the content C1 from the server 20, the user terminal 10 outputs the content C1 by causing the UI 154 to display the image of the content C1. The requester Ua checks the content C1 by using the UI 154.

In the case of a system in which a specific user (a content creator or a manager) judges whether to grant an access right for content, if a request to set an access right is received while the specific user is absent, it may take time to determine whether to grant an access right. In contrast, in this exemplary embodiment, in response to a request to set an access right for a certain piece of content, a voting request is sent to plural authorization holders having an access right for this piece of content to request them to vote upon whether to accept the request. Calculation processing is then executed on voting results obtained from the authorization holders, and it is then judged whether to grant an access right based on the calculation results. It is thus possible to reduce the time taken to decide whether to grant an access right for content in response to a request to set an access right for this content.

In a system of the related art, it may be difficult for a content creator to verify the identity of a requester having requested to set an access right for content. This may make it difficult for the content creator to judge whether to grant an access right to the requester. In contrast, in this exemplary embodiment, a voting request is sent to a user who is a friend of a requester and is also located in the same time zone as that of the requester, thereby enhancing the reliability concerning the identity of the requester.

### [3] MODIFIED EXAMPLES

The above-described exemplary embodiment is only an example and may be modified in the following manner. Additionally, the above-described exemplary embodiment and the following modified examples may be combined according to the necessity.

(1) In the above-described exemplary embodiment, in response to a request to set an access right for content, the server 20 extracts users having authorization to change rights for this content as authorization holders (step S302 in FIG. 9). The server 20 then narrows down the extracted authorization holders in accordance with the predetermined conditions (step S303 in FIG. 9) and then requests the selected authorization holders to vote upon whether to accept the request to set an access right. However, the server 20 may select users to be requested to vote in a different manner. For example, the server 20 may send a voting request to all the users registered in the ACL for the content for which an access right will be set.

(2) In the above-described exemplary embodiment, when narrow-down processing is executed, authorization holders are restricted (users to be requested to vote are selected) based on whether an authorization holder and a requester are friends in an SNS and whether the time zone of an authorization holder is the same as that of the requester. However, authorization holders may be selected in a different manner. For example, the server 20 may compare position information concerning a requester and that concerning an authorization holder to calculate the distance between the position of the requester and that of the authorization holder. The server 20 then select authorization holders for which the calculated distance is smaller than or equal to a predetermined threshold.

Alternatively, the server 20 may restrict the authorization holders extracted in step S302 of FIG. 9 to authorization holders whose network connection state in the account is online.

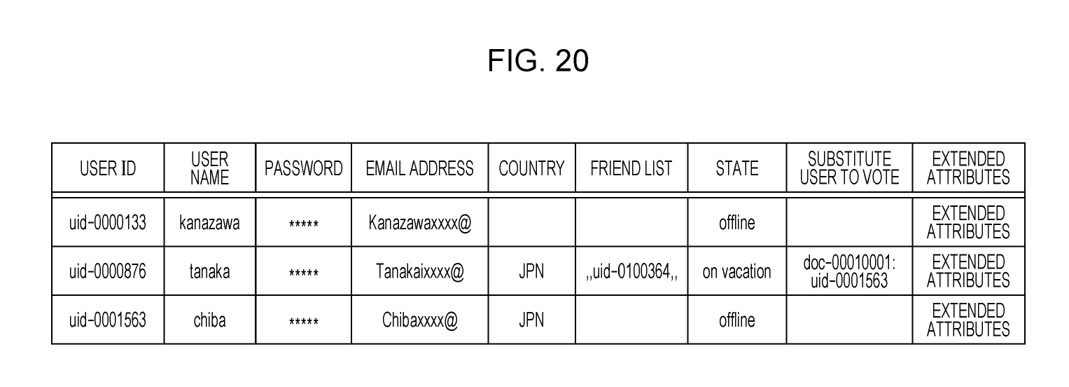

FIG. 20 illustrates an example of a list of authorization holders. In FIG. 20, the server 20 selects an authorization holder whose “state” is “online” from among the extracted authorization holders.

(3) When narrow-down processing is executed, authorization holders may be restricted by using, not only the physical distance represented by the time zone, but also the psychological distance determined by how often an authorization holder exchanges messages with a requester, for example. More specifically, the server 20 may calculate the frequency of exchanging of messages with a requester, and then select authorization holders for which the calculated frequency level is greater than or equal to a predetermined threshold.

(4) When narrow-down processing is executed, the server 20 may make a judgement whether an authorization holder is a malicious user. The server 20 may make this judgement according to whether an authorization holder is registered in a preset blacklist. In this case, the server 20 requests only well-intended authorization holders to vote.

(5) An authorization holder may specify a substitute user to vote when the authorization holder is absent. In this case, the authorization holder specifies a substitute user for each piece of content. If an authorization holder is absent, the processor 252 of the server 20 sends a voting request to a substitute user specified by the authorization holder. The example in FIG. 20 shows that the user of the user ID “uid-0000876” has delegated the user of the user ID “uid-0001563” to vote upon whether to accept a request to set an access right for the content identified by “doc-00010001” if the user is absent.

(6) The server 20 may change the conditions (calculation method and/or thresholds, for example) used for judging whether to grant an access right in accordance with the attributes of content and/or the type of access right. For example, the server 20 may change the threshold used in judging processing for calculation results in accordance with the attributes of content (confidentiality of the content, how long the content has been disclosed, and so on). More specifically, the server 20 may use the conditions that an access right is less likely to be set for content having a higher level of confidentiality or that an access right is more likely to be set for content which has been disclosed for a longer time. Among plural calculation expressions, the server 20 executes calculation processing by using an expression corresponding to the attributes of the content. In this case, the creator of the content may perform linking of the calculation method and/or the threshold with the content.

(7) A content creator, for example, may set a setting so that voting processing will not be conducted depending on the type of content or the confidentiality of content. In this case, only when the attributes of content (the type of content or the confidentiality of content) satisfy predetermined conditions (an example of a second condition), does the server 20 send a voting request to users, execute calculation processing on voting results received from the users, and judge whether to grant an access right by using the calculation results. In this case, concerning content for which voting processing will not be conducted, the server 20 requests the content creator to set an access right for this content. That is, the content creator judges whether to grant an access right.

(8) The server 20 may change the approach to extracting authorization holders in accordance with the type of access right to be granted. For example, it may be necessary to more carefully choose who will be consulted for granting authorization to change rights than to choose for granting a read right. The threshold may be set so that judging conditions for granting authorization to change rights will be stricter than those for a read right.

(9) When conducting calculation processing for voting results, the server 20 may apply a weight to the voting result of each authorization holder in accordance with the relationship between the attributes of an authorization holder and those of a requester (user corresponding to a setting request to set an access right). In one example, the server 20 may apply a greater weight to the voting result of an authorization holder who is closer to a requester. More specifically, as the physical distance and/or psychological distance of an authorization holder are closer to those of the requester, a greater weight may be applied to the voting result of the authorization holder. In another example, the server 20 may increase the weight to be applied to the voting result of an authorization holder located in the same time zone as that of a requester.

(10) Content may be divided into plural portions according to the logical structure, and an access right may be set for each portion of the content. In this case, the server 20 judges whether to grant an access right for each portion of the content. For example, if the content is document data, an access right may be set for each portion of the document data in the following manner. All users can read the front cover without imposing any restrictions on access rights. Only some users satisfying predetermined conditions can read the table of contents. For the other pages of the document data, conditions stricter than those for the table of contents are set, and only some users satisfying these conditions can read the other pages. In this case, concerning granting of access rights to the entirety of the content, judgement may be put on hold until a more qualified person is available or the content creator is able to make a judgement.

(11) When an access right for content is granted to a requester user, as this requester user makes better use of the content, a higher incentive may be provided to a user accepted to grant an access right to this requester user.

(12) The programs executed by the processor 252 of the server 20 may be downloaded via a communication line, such as the Internet. The programs may be provided as a result of being recorded in a computer readable recording medium, such as a magnetic recording medium (magnetic tape and a magnetic disk, for example), an optical recording medium (an optical disc, for example), a magneto-optical recording medium, or a semiconductor memory.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiment was chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An information processing apparatus comprising:
a receiver that receives a setting request to set an access right to access content for a user;
a sender that sends a voting request to a user authorized to access the content, the voting request being a request to vote upon whether to accept the setting request; and
a setter that executes calculation processing on information received in response to the voting request and sets the access right if a result of the calculation processing satisfies a predetermined condition.

2. The information processing apparatus according to claim 1, wherein, among users authorized to access the content, the sender sends the voting request to a user having an attribute which satisfies a predetermined condition.

3. The information processing apparatus according to claim 2, wherein, among the users authorized to access the content, the sender sends the voting request to a user whose network connecting state is online.

4. The information processing apparatus according to claim 1, wherein, when executing the calculation processing on the received information, the setter applies a weight to the received information in accordance with a relationship between an attribute of a user corresponding to the setting request and an attribute of a user corresponding to the received information.

5. The information processing apparatus according to claim 4, wherein the setter applies the weight to the received information in accordance with a distance between the user corresponding to the setting request and the user corresponding to the received information.

6. The information processing apparatus according to claim 1, wherein the setter changes the predetermined condition in accordance with an attribute of the content.

7. The information processing apparatus according to claim 1, wherein the setter sets the access right by using the result of the calculation processing if an attribute of the content satisfies a predetermined second condition.

8. The information processing apparatus according to claim 1, wherein, among a plurality of calculation expressions, the setter executes the calculation processing by using a calculation expression corresponding to an attribute of the content.

9. A non-transitory computer readable medium storing a program causing a computer to execute a process, the process comprising:
receiving a setting request to set an access right to access content for a user;
sending a voting request to a user authorized to access the content, the voting request being a request to vote upon whether to accept the setting request; and
executing calculation processing on information received in response to the voting request and setting the access right if a result of the calculation processing satisfies a predetermined condition.

10. An information processing apparatus comprising:
receiving means for receiving a setting request to set an access right to access content for a user;
sending means for sending a voting request to a user authorized to access the content, the voting request being a request to vote upon whether to accept the setting request; and
setting means for executing calculation processing on information received in response to the voting request and for setting the access right if a result of the calculation processing satisfies a predetermined condition.
